(19) United States
(12) Patent Application Publication
(10) Pub. No.: US 2008/0304619 A1
(43) Pub. Date: Dec. 11, 2008

(54) Modular Multi-Hole Collimators Method and System

(75) Inventors: Ira Blevis, Zichron Yaakov (IL); Yaron Hefetz, Herzeliya (IL); James William Hugg, Glenville, NY (US); Floribertus P.M. Heukensfeldt Jansen, Ballston Lake, NY (US); Jorge Uribe, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/759,783

(22) Filed: Jun. 7, 2007

(51) Int. Cl. G21K 1/02; G01N 23/08

(52) U.S. Cl. 378/16; 378/149

(57) ABSTRACT

Embodiments of the present technique relate to a modular multi-hole collimator assembly configured to have an adjustable length. Each of the two or more multi-hole collimator units has a plurality of holes therethrough. Exemplary embodiments also relate to a modular multi-hole collimator assembly that includes a base multi-hole collimator unit and one or more multi-hole collimator extension units. Each of the base multi-hole collimator unit and the one or more multi-hole collimator extension units has a plurality of holes therethrough. At least one of the plurality of holes through the base multi-hole collimator unit and at least one of the holes through the one or more multi-hole collimator extension units are axially aligned.

### BACKGROUND

The invention relates generally to non-invasive imaging such as single photon emission computed tomography (SPECT) or planar gamma ray imaging. More particularly, the invention relates to modular multi-hole collimators for use in non-invasive imaging.

SPECT is used for a wide variety of imaging applications, such as medical imaging. In general, SPECT systems are imaging systems that are configured to generate an image based upon the impact of photons (generated by a nuclear decay event) against a gamma-ray detector. In medical and research contexts, these detected photons may be processed to formulate an image of organs or tissues beneath the skin.

To produce a planar image, one or more detector assemblies may be placed in stationary positions around a subject. To produce a SPECT image, one or more detector assemblies may be rotated around a subject. Detector assemblies are typically comprised of various structures working together to receive and process the incoming photons. For instance, the detector assembly may utilize a scintillator assembly (e.g., large sodium iodide scintillator plates) to convert the photons into visible light for detection by an optical sensor. This scintillator assembly may be coupled by a light guide to multiple photomultiplier tubes (PMTs) or other light sensors that convert the light from the scintillator assembly into an electric signal. In addition to the scintillator assembly-PMT combination, pixilated solid-state direct conversion detectors (e.g., CZT) may also be used to generate electric signals from the impact of the photons. This electric signal can be transferred, converted, and processed by electronic modules in a data acquisition module to facilitate viewing and manipulation by clinicians.

Typically, SPECT systems further include a collimator assembly that may be attached to the front of the gamma-ray detector. In general, the collimator assembly is designed to absorb photons such that only photons traveling in certain directions impact the detector assembly. For example, multi-hole collimators having multiple, small-diameter channels separated by lead septa have been used. With these multi-hole collimators, photons that are not traveling through the channels in a direction generally parallel to the lead septa are absorbed. In addition, while multi-hole collimators having parallel holes (e.g., parallel-hole collimators) are commonly used, multi-hole collimators also may have converging holes for image magnification or diverging holes for minifying the image.

In general, the collimator assembly selected for use with the SPECT system impacts the system performance thereof, including image resolution and sensitivity. Because resolution and sensitivity may be traded off along a collimator performance curve for each SPECT system, a single operating point is typically selected when designing a collimator assembly. In other words, a collimator assembly is typically designed to operate at a single operating point on the resolution-sensitivity tradeoff performance curve. Different applications, however, may benefit from operating with different tradeoffs on the performance curve. By way of example, small organ imaging typically may require higher resolution and lower sensitivity, whereas imaging a large volume (such as for possible lesions) typically may require higher sensitivity with lower resolution.

To provide a SPECT system with different tradeoffs on the performance curve, multiple collimator assemblies may be provided for each SPECT system with each of the collimator assemblies having a different performance point. In this manner, a user may have a choice in selecting a collimator assembly with an appropriate operating point for a particular application. Accordingly, when the user changes applications, the most appropriate collimator assembly must be mounted on the SPECT system. Collimator assemblies, however, are typically heavy, generally comprising lead with a thickness sufficient to block gamma rays so that the collimator exchange is a time consuming process. To minimize this time-consuming exchange, extra effort may be made to schedule blocks of patients with similar examination requirements, for example, in clinical laboratories. In addition to the problems associated with the time-consuming exchange of the collimator assemblies, the purchase and storage of multiple collimator assemblies is costly.

Accordingly, it would be desirable to provide an imaging system with collimator assemblies having different operating points along the resolution-sensitivity tradeoff performance curve while reducing the need for multiple collimator assemblies.

### BRIEF DESCRIPTION

In accordance with one embodiment, the present technique provides a collimator assembly. The collimator assembly includes a modular multi-hole collimator assembly configured to have an adjustable length by coupling two or more multi-hole collimator units. Each of the two or more multi-hole collimator units has a plurality of holes therethrough.

In accordance with another embodiment, the present technique provides a modular multi-hole collimator assembly. The modular multi-hole collimator assembly includes a base multi-hole collimator unit having a plurality of holes therethrough. The modular multi-hole collimator assembly further includes a multi-hole collimator extension unit having a plurality of holes therethrough. At least one of the plurality of holes through the base multi-hole collimator unit and at least one of the holes through the multi-hole collimator unit are axially aligned.

In accordance with another embodiment, the present technique provides an imaging system that includes a modular multi-hole collimator assembly configured to have an adjustable length by coupling two or more multi-hole collimator units. Each of the two or more multi-hole collimator units has a plurality of holes therethrough. The imaging system further includes a detector assembly configured to generate one or more signals in response to gamma rays that pass through pathways defined by the modular multi-hole collimator assembly.

In accordance with another embodiment, the present technique provides a method of changing collimator performance. The method includes coupling a multi-hole collimator extension unit having a plurality of holes therethrough to a base collimator unit having a plurality of holes therethrough so that at least one of the plurality of holes through the base multi-hole collimator unit and at least one of the holes through the first multi-hole collimator extension unit are axially aligned.

In accordance with another embodiment, the present technique provides a method of changing collimator performance. The method includes removing a multi-hole collimator extension unit having a plurality of holes therethrough from a modular collimator assembly. The modular collimator assembly includes the multi-hole collimator extension unit coupled to a base multi-hole collimator unit having a plurality of holes therethrough. At least one of the plurality of holes through the base multi-hole collimator unit at least one of the holes through the multi-hole collimator extension unit are axially aligned.

In accordance with another embodiment, the present technique provides a method of imaging a volume. The method includes positioning at least a portion of a subject in a field of view of an imaging system. The method further includes collimating gamma rays emitted from the subject using a modular multi-hole collimator assembly. Gamma rays aligned with pathways formed by holes of the modular multi-hole collimator assembly pass through the modular multi-hole collimator assembly. The modular multi-hole collimator assembly at least substantially absorbs gamma rays not aligned with one of the pathways. The method further includes detecting the collimated gamma rays. The method further includes generating one or more signals in response to the collimated gamma rays.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an exemplary SPECT system which may include a modular multi-hole collimator assembly in accordance with embodiments of the present technique;

FIG. 2 is an illustration of an exemplary multi-hole collimator assembly and detector assembly in accordance with embodiments of the present technique;

FIGS. 3-5 illustrate exemplary modular multi-hole collimator assemblies in accordance with embodiments of the present technique;

FIG. 6 illustrates a modular multi-hole collimator assembly having a diverging hole configuration in accordance with embodiments of the present technique; and

FIG. 7 illustrates a modular multi-hole collimator assembly having a converging hole configuration in accordance with embodiments of the present technique.

### DETAILED DESCRIPTION

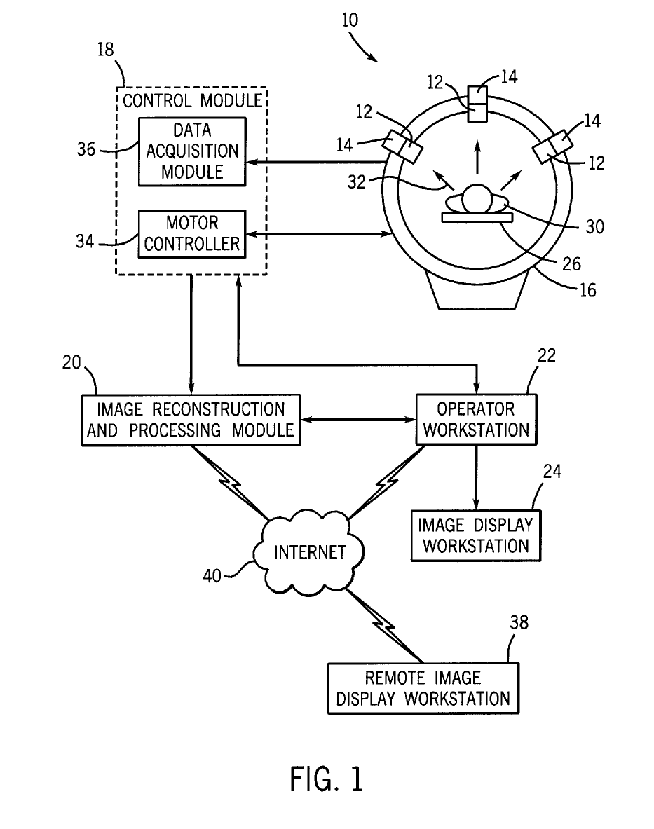

FIG. 1 illustrates an exemplary SPECT system 10 for acquiring and processing image data in accordance with exemplary embodiments of the present technique. As illustrated, the SPECT system 10 may include one or more modular multi-hole collimator assemblies 12 and one or more detector assemblies 14 mounted on a gantry 16. As will be discussed in more detail below, the modular multi-hole collimator assembly may be configured to have an adjustable length by coupling two or more multi-hole collimator units. In the illustrated embodiment, the SPECT system 10 also includes a control module 18, an image reconstruction and processing module 20, an operator workstation 22, and an image display workstation 24. Each of the aforementioned components will be discussed in greater detail in the sections that follow.

As illustrated, a subject support 26 (e.g. a table) may be moved into position in a field of view 28 of the SPECT system 10. In the illustrated embodiment, the subject support 26 is configured to support a subject 30 (e.g., a human patient, a small animal, a plant, a porous object, etc.) in a position for scanning. Alternatively, the subject support 26 may be stationary, while the SPECT system 10 may be moved into position around the subject 30 for scanning. Those of ordinary skill in the art will appreciate that the subject 30 may be supported in any suitable position for scanning. By way of example, the subject 30 may be supported in the field of view 28 in a generally vertical position, a generally horizontal position, or any other suitable position (e.g., inclined) for the desired scan. In SPECT imaging, the subject 30 is typically injected with a solution that contains a radioactive tracer. The solution is distributed and absorbed throughout the subject 30 in different degrees, depending on the tracer employed and, in the case of living subjects, the functioning of the organs and tissues. The radioactive tracer emits electromagnetic rays (e.g., photons or gamma quanta) known as “gamma rays” during a nuclear decay event, represented on FIG. I as gamma rays 32.

As previously mentioned, the SPECT system 10 includes one or more modular multi-hole collimator assemblies 12 that receive the gamma rays 32 emanating from the subject 30 positioned in the field of view 28. In the illustrated embodiment, three modular multi-hole collimator assemblies 12 are mounted on the gantry 16 and are spaced about 120° apart. Each of the modular multi-hole collimator assemblies 12 may be disposed between one of the detector assemblies 14 and the field of view 28. In general, the modular multi-hole collimator assemblies 12 are configured to limit and define the direction and angular divergence of the gamma rays 32. As will be discussed in more detail with respect to the following figures, the modular multi-hole collimator assemblies 12 are generally configured to have an adjustable length by coupling of two or more multi-hole collimator units. In this manner, the geometric configuration of the modular multi-hole collimator assemblies can be modified without the need to swap an entire collimator assembly. Moreover, the modular multi-hole collimator assemblies 12 may contain a radiation-absorbent material, such as lead or tungsten, for example. Referring again to FIG. 1, three modular multi-hole collimator assemblies 12 are illustrated that are spaced about 120° around the circumference of the gantry 16. In exemplary embodiments, any number of multi-hole collimator assemblies 12 may be implemented in the SPECT system 10 in accordance with exemplary embodiments of the present technique. By way of example, one, two, three, four, or more multi-hole collimator assemblies 12 may be utilized.

The gamma rays 32 that pass through the openings in the modular multi-hole collimator assemblies 12 impact the one or more detector assemblies 14. Due to the collimation of the gamma rays 32 by the modular multi-hole collimator assemblies 12, the detection of the gamma rays 32 may be used to determine the line of response along which each of the gamma rays 32 traveled before impacting the detector assemblies 14, allowing localization of each gamma ray's origin to that line. In general, each of the detector assemblies 14 may includes a plurality of detector elements configured to detect the gamma rays 32 emanating from the subject 30 in the field of view 28 and passing through one or more hole through the modular multi-hole collimator assemblies 12. In exemplary embodiments, each of the plurality of detector elements in the detector assemblies 14 produces an electrical signal in response to the impact of the gamma rays 32.

Moreover, any number of detector assemblies 14 may be implemented in the SPECT system 10 and arranged therein. By way of example, one, two, three, four, or more detector assemblies 14 may be utilized. In the illustrated embodiment, three detector assemblies 14 are illustrated that are spaced about 120° around the circumference of the gantry 16.

As will be appreciated by those of ordinary skill in the art, the detector elements of the detector assemblies 14 may include any of a variety of suitable materials and/or circuits for detecting the impact of the gamma rays 32. By way of example, the detector elements may include a plurality of solid-state detector elements, which may be provided as one-dimensional or two-dimensional arrays. In another embodiment, the detector elements of the detector assemblies 14 may include a scintillation assembly and PMTs or other light sensors.

In the illustrated embodiment, the modular multi-hole collimator assemblies 12 and the detector assemblies 14 are mounted on the gantry 16. In addition to supporting the collimator assemblies 12 and the detector assemblies 14 in the desired position, the gantry 16 may also be configured to rotate about the subject 30 to acquire multiple lines of response emanating therefrom.

SPECT system 10 further includes a control module 18. In the illustrated embodiment, the control module 18 includes a motor controller 34 and a data acquisition module 36. In general, the motor controller 34 may control the rotational speed and position of the gantry 16 and/or the position of the subject support 26. The data acquisition module 36 may be configured to obtain the signals generated in response to the impact of the gamma rays 32 with the detector assemblies 14. For example, the data acquisition module 36 may receive sampled electrical signals from the detector assemblies 14 and convert the data to digital signals for subsequent processing by the image reconstruction and processing module 20.

Those of ordinary skill in the art will appreciate that any suitable technique for data acquisition may be used with the SPECT system 10. By way of example, the data needed for image reconstruction may be acquired in a list or a frame mode. In one exemplary embodiment of the present technique, gamma ray events (e.g., the impact of gamma rays 32 on the detector assemblies 14), gantry 16 motion (e.g., modular multi-hole collimator assemblies 12 motion and subject support 26 position), and physiological signals (e.g., heart beat and respiration) may be acquired in a list mode. List mode may be suitable in exemplary embodiments where the count rate is relatively low and many pixels record no counts at each gantry position or physiological gate. Alternatively, frames and physiological gates may be acquired by moving the gantry in a step-and-shoot manner and storing the number of events in each pixel during each frame time and heart or respiration cycle phase. Frame mode may be suitable, for example, where the count rate is relatively high and most pixels are recording counts at each gantry position or physiological gate.

In the illustrated embodiment, the image reconstruction and processing module 20 is coupled to the data acquisition module 36. The signals acquired by the data acquisition module 36 may be provided to the image reconstruction and processing module 20 for image reconstruction. The image reconstruction and processing module 20 may include electronic circuitry to provide the drive signals, electronic circuitry to receive acquired signals, and electronic circuitry to condition the acquired signals. Further, the image reconstruction and processing module 20 may include processing to coordinate functions of the SPECT system 10 for implementing reconstruction algorithms suitable for reconstruction of the acquired signals. The image reconstruction and processing module 20 may include a digital signal processor, memory, a central processing unit (CPU) or the like, for processing the acquired signals. As will be appreciated, the processing may include the use of one or more computers. The addition of a separate CPU may provide additional functions for image reconstruction, including, but not limited to, signal processing of data received, and transmission of data to the operator workstation 22 and image display workstation 24. In one embodiment, the CPU may be confined within the image reconstruction and processing module 20, while in another embodiment a CPU may include a stand-alone device that is separate from the image reconstruction and processing module 20.

The reconstructed image may be provided to the operator workstation 22. The operator workstation 22 may be utilized by a system operator to provide control instructions to some or all of the described components and for configuring the various operating parameters that aid in data acquisition and image generation. An image display workstation 24 coupled to the operator workstation 22 may be utilized to observe the reconstructed image. It should be further noted that the operator workstation 22 and the image display workstation 24 may be coupled to other output devices, which may include printers and standard or special purpose computer monitors. In general, displays, printers, workstations and similar devices supplied with the SPECT system 10 may be local to the data acquisition components, or may be remote from these components, such as elsewhere within the institution or hospital, or in an entirely different location, linked to the image acquisition system via one or more configurable networks, such as the Internet, virtual private networks, and so forth. By way of example, the operator workstation 22 and/or the image reconstruction and processing module 20 may be coupled to a remote image display workstation 38 via a network (represented on FIG. 1 as Internet 40).

Furthermore, those of ordinary skill in the art will appreciate that any suitable technique for image reconstruction may be used with the SPECT system 10. In one exemplary embodiment, iterative reconstruction (e.g., ordered subsets expectation maximization, OSEM) may be used. Iterative reconstruction may be suitable for certain implementations of the SPECT system 10 due, for example, to its speed and the ability to tradeoff reconstruction resolution and noise by varying the convergence and number of iterations.

While in the illustrated embodiment, the control module 18 (including the data acquisition module 36 and the motor controller 34) and the image reconstruction and processing module 20 are shown as being outside the detector assemblies 14 and the operator workstation 22. In certain other implementations, some or all of these components may be provided as part of the detector assemblies 14, the operator workstation 22, and/or other components of the SPECT system 10.

Those of ordinary skill in the art will appreciate that the performance of the SPECT system 10 is at least partially based on the geometric configuration of the collimator assembly selected for use therewith. By way of example, the size, shape and length of the holes through a multi-hole collimator assembly impact the system resolution and sensitivity. In general, system resolution and sensitivity may be traded off along a resolution-sensitivity tradeoff curve. In some instances, conventional collimator assemblies may be designed to operate at only a single operating point on the resolution-sensitivity tradeoff curve. Different applications, however, may benefit from operating with different tradeoffs on the performance curve. To provide different resolutions and sensitivities, multiple multi-hole collimator assemblies may be provided for each SPECT system with each collimator assembly having a different performance point. However, this may add undesired expense and complexity associated with obtaining, storing and swapping the collimator assemblies.

An embodiment of the present technique provides one or more modular multi-hole collimator assemblies 12 that reduce the need for multiple entire collimator assemblies. In accordance with embodiments of the present technique, each of the modular multi-hole collimator assemblies 12 may be configured to have an adjustable length by coupling two or more multi-hole collimator units. In this manner, the length of holes through the collimator assembly may be increased, changing the geometric configuration of the collimator assembly. Conversely, the length of the holes through the modular multi-hole collimator assembly may be shortened through removal of one or more multi-hole collimator units. Those of ordinary skill in the art will appreciate that these changes in the collimator assembly's geometric configuration will generally result in different resolutions and sensitivities for the SPECT system 10 into which the modular multi-hole collimator assemblies 12 are incorporated. For example, lengthening the holes to the modular multi-hole collimator assemblies 12 should increase resolution while decreasing sensitivity of the SPECT system 10. Conversely, shortening the holes through the modular multi-hole collimator assemblies 12 should decrease system resolution while increasing system sensitivity. In exemplary embodiments, a user may assemble a modular multi-hole collimator assembly having two or more multi-hole collimator units based on the desired performance points for the SPECT system 10. For example, a user may select multi-hole collimator units for a multi-hole collimator assembly to have a desired length to provide a particular resolution and sensitivity for the SPECT system.

In certain embodiments, utilizing one or more modular multi-hole collimator assemblies 12 to change the performance of the SPECT system 10 may reduce the expense and complexity associated with obtaining, storing and swapping multiple collimator assemblies. While embodiments of the present technique will generally involve obtaining, storing and swapping multiple multi-hole collimator units, the expense and complexity associated therewith should be reduced as compared to the expense and complexity associated with entire collimator assemblies. Indeed, each of the modular multi-hole collimator units may weigh significantly less than a conventional unitary collimator assembly, for example. Further, in certain embodiment, changing the geometric configuration of the modular multi-hole collimator assemblies 12 will generally not require removal of the collimator base, but rather adding (or removing) multi-hole collimator units from an installed base.

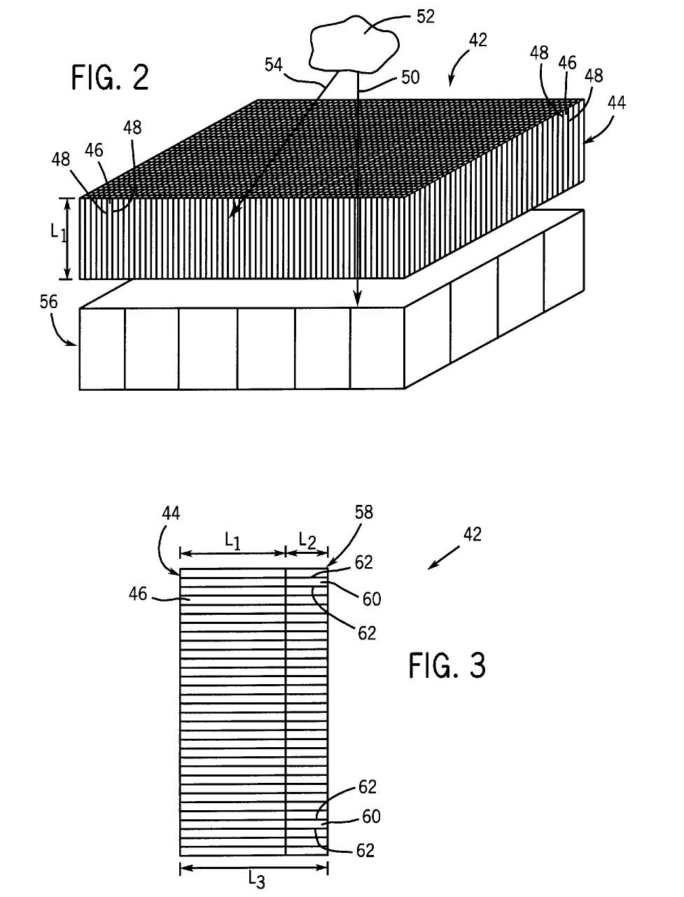

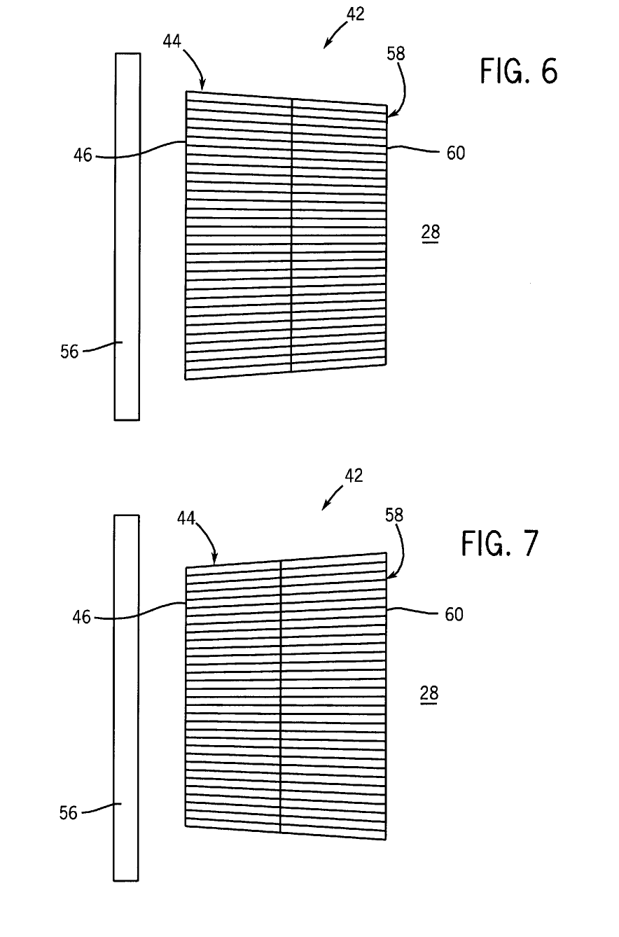

Referring now to FIG. 2, a modular multi-hole collimator assembly 42 is illustrated in accordance with embodiments of the present technique. In the illustrated embodiment, the modular multi-hole collimator assembly 42 includes a base multi-hole collimator unit 44. As illustrated, the base multi-hole collimator unit 44 includes a plurality of base holes 46 therethrough that are generally parallel to one another. As will be discussed in more detail below with respect to FIGS. 6 and 7, collimators with alternative hole configurations (e.g., converging or diverging) are also encompassed by the present technique. Further, those of ordinary skill in the art will appreciate that the base holes 46 may also be referred to as channels. In the illustrated embodiment, the plurality of base holes 46 are separated by base septa 48. In accordance with embodiments of the present technique, the base septa 48 may contain a radiation-absorbent material, such as lead or tungsten, for example.

As illustrated, gamma rays (such as aligned gamma ray 50) emanating from an object 52 that are traveling in a direction generally parallel to the base septa 48 pass through the base holes 46 in the base multi-hole collimator unit 44. As illustrated, gamma ray 50 passes through the base multi-hole collimator unit 44 as it is aligned with one of the base holes 46 therethrough and is traveling in a direction parallel to the base septa 48 forming that hole. Gamma rays (such as unaligned gamma ray 54) emanating from the object 52 that are not traveling in a direction generally parallel to the base septa 48 do not pass through the base holes 46 and should be absorbed by the base septa 48. As illustrated, the aligned gamma rays 50 that pass through the base holes 46 impact the detector assembly 56. The detector assembly 56 generally may produce a signal in response to the detected gamma rays for subsequent processing, as previously described.

As previously mentioned, the performance of the SPECT system 10 may be at least partially based on the geometric configuration of the collimator assembly selected for use therewith. By way of example, the length, diameter and shape of the holes through the modular multi-hole collimator unit 42 should impact the system resolution and sensitivity. By way of example, consider the design of multi-hole collimators for gamma rays of energy 140 keV. The base holes 46 through the base multi-hole collimator unit 44 may have a hole length (L₁) in the range of from about 5 millimeters to about 50 millimeters, for example. More particularly, the base holes 46 may have a length in the range of from about 10 millimeters to about 25 millimeters, for example. The base holes 46 through the base multi-hole collimator unit 44 may have a diameter in the range of from about 0.5 millimeter to about 5 millimeters, for example. More particularly, the base holes 46 may have a diameter in the range of from about 1 millimeter to about 3 millimeters, for example. The base holes 46 through the base multi-hole collimator unit 44 may have base septa 48 with a thickness in the range of from about 0.1 millimeter to about 2 millimeters, for example. More particularly, the base septa 48 may have a thickness in the range from about 0.1 millimeter to about 0.4 millimeters, for example. Those of ordinary skill in the art will appreciate that the above-listed ranges are merely exemplary and the present technique encompasses the use of collimator units having dimensions outside these ranges. Further, the base holes 46 may have any of a variety of different shapes, such as circular, square, or hexagonal, and the like.

To change the geometric configuration of the modular multi-hole collimator assembly 42, one or more multi-hole collimator extension units may be coupled to the base multi-hole collimator unit 44, changing the length of the holes through the modular multi-hole collimator assembly 42. In this manner, the sensitivity and resolution of the SPECT system 10, into which the modular multi-hole collimator assembly 42 may be incorporated, may be modified. As previously mentioned, increasing the length of the holes through the modular multi-hole collimator assembly 42 should increase system resolution at the expense of sensitivity.

FIG. 3 illustrates the modular multi-hole collimator assembly 42 having a multi-hole collimator extension unit 58 coupled to the base multi-hole collimator unit 44. As illustrated, the multi-hole collimator extension unit 58 includes a plurality of extension holes 60 therethrough that are aligned with the base holes 46 through the base multi-hole collimator unit 44. In general, the extension holes 60 through the collimator extension unit 58 may have diameters that are the same as the diameter of the base holes 46 through the base multi-hole collimator unit 42. However, collimator extension units having hole diameters or shapes different than the hole diameters and shapes of the base collimator units are also encompassed by the present technique. Furthermore, in the illustrated embodiment, the extension holes 60 through the multi-hole collimator extension unit 58 are separated by extension septa 62. In accordance with embodiments of the present technique, the extension septa 62 may contain a radiation-absorbent material, such as lead or tungsten, for example.

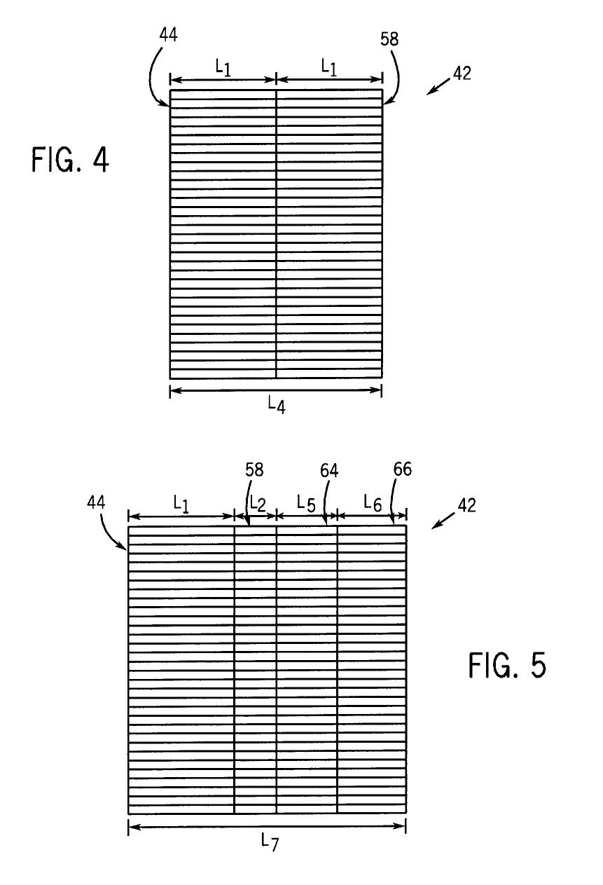

In the illustrated embodiment, the multi-hole collimator extension unit 58 has a hole length of L₂, and the base multi-hole collimator unit 44 has a hole length of L₁. Accordingly, the modular multi-hole collimator assembly 42 formed from this combination has a hole length of L₃, wherein L₁ plus L₂ equals L₃. While FIG. 3 illustrates the base multi- hole collimator unit 58 and the multi-hole collimator extension unit 58 as having different lengths, those of ordinary skill will appreciate that the multi-hole collimator units used to assemble the modular multi-hole collimator assembly 56 may have lengths that are the same or different. For example, FIG. 4 illustrates the modular multi-hole collimator assembly 42 including the base multi-hole collimator unit 44 and the multi-hole collimator extension unit 58. As illustrated in FIG. 4, the multi-hole collimator extension unit 58 has a hole length L₁ that is equal to the hole length L₁ of the base multi-hole collimator unit 44. Accordingly, the modular multi-hole collimator assembly 42 formed from this combination has a hole length of L₄, wherein L_{1 plus L}₁ equals L₄.

In general, the multi-hole collimator extension units (such as the first multi-hole collimator extension unit 58) may have any of a variety of different hole lengths based on, for example, the desired system resolution and sensitivity. By way of example, the multi-hole collimator extension units may have hole lengths in the range of from about 2 millimeters to about 30 millimeters, for example. More particularly, the multi-hole collimator extension units may have hole lengths in the range of from about 2 millimeters to about 15 millimeters, for example. Those of ordinary skill in the art will appreciate that the above-listed ranges are merely exemplary and the present technique encompasses the use of collimator units having dimensions outside these ranges. In general, the multi-hole collimator unit (or units where multiple extension units are used) may be selected to, in combination with the base multi-hole collimator unit, provide a modular multi-hole collimator with a desired hole length.

Furthermore, those of ordinary skill in the art will appreciate that any number of multi-hole collimator extension units (such as multi-hole extension unit 58) may be used to provide the modular multi-hole collimator assembly 42 with the desired hole length, in accordance with embodiments of the present technique. For example, two, three, four or more multi-hole collimator units may be assembled to provide a modular multi-hole collimator assembly 42 with the desired resolution and sensitivity. As illustrated in FIGS. 3 and 4, the modular multi-hole collimator assembly 42 includes two collimator units, the base multi-hole collimator unit 44 and the multi-hole collimator extension unit 58. FIG. 5 illustrates the modular multi-hole collimator assembly 42 as including four collimator units. As illustrated, the modular multi-hole collimator assembly 42 includes the base multi-hole collimator unit 44 having a hole length of L₁. Further, the multi-hole collimator extension unit 58 having a hole length of L₂ may be coupled to the base multi-hole collimator unit 58. In addition, a second multi-hole collimator extension unit 64 may be coupled to the multi-hole collimator extension unit 58. In the illustrated embodiment, the second multi-hole collimator extension unit 64 has a hole length of L₅. Moreover, a third multi-hole collimator extension unit 66 having a hole length of L₆ may be coupled to the second multi-hole collimator extension unit 64. Accordingly, the modular multi-hole collimator assembly 42 formed from this combination has a hole length of L₇, wherein L₁ plus L₂ plus L₅ plus L₆ equals L₇. Those of ordinary skill in the art will appreciate that the construction details of the second and third multi-hole collimator extension units 64 and 66 may be similar to those described above for the base multi-hole collimator unit 44 and the first multi-hole collimator extension unit 58.

Moreover, while the preceding discussion has described the modular multi-hole collimator assembly 42 as having a parallel hole configuration, those of ordinary skill in the art will appreciate that a variety of different hole configurations are encompassed by the present technique. For example, FIG. 6 illustrates the modular multi-hole collimator assembly 42 as having a converging hole configuration. As illustrated, in a converging hole configuration, the base holes 46 through the base multi-hole collimator unit 44 and the extension holes 60 through the first collimator extension unit 60 are focused on the field of view 28, in that the holes generally converge from the detector assembly 56 to the field of view 28. A converging hole configuration may be used, for example, where it is desired to magnify the field of view 28. FIG. 7 illustrates the modular multi-hole collimator assembly 42 as having a diverging hole configuration. As illustrated, in a diverging hole configuration, the base holes 46 through the base multi-hole collimator unit 44 and the extension holes 60 through the first collimator extension unit 58 generally diverge from the detector assembly 56 to the field of view 28. As will be appreciated in the diverging hole configuration, the base hole 46 and extension holes 60 generally converge from the field of view 28 to the detector assembly 56. A diverging hole configuration may be used, for example, where it is desired to minify the field of view 28.

As described above, the performance and sensitivity of the SPECT system 10 is at least partially based on the geometric configuration of the collimator assembly selected for use therewith. Table 1 below illustrates different performance points for a set of “low energy” (up to 159 keV) collimator assemblies having a 1.5 millimeter hexagonal diameter and a 0.2 millimeter septa thickness. In the following table, septal penetration is calculated for a lead (Pb) collimator.

TABLE 1

| | LEHVR | LEHR | LEGP | LEHS | LEVHS |
|---|---|---|---|---|---|
| Hole Diameter | 1.5 | 1.5 | 1.5 | 1.5 | 1.5 |
| (mm) | | | | | |
| Septa | 0.2 | 0.2 | 0.2 | 0.2 | 0.2 |
| Thickness | | | | | |
| (mm) | | | | | |
| Hole Length | 44 | 35 | 26 | 21 | 17 |
| (mm) | | | | | |
| System | 6.6 | 7.5 | 9.1 | 10.6 | 12.6 |
| Resolution at | | | | | |
| 10 cm (mm) | | | | | |
| Sensitivity | 150 | 170 | 310 | 490 | 755 |
| (cpm/microCi) | | | | | |
| Maximum | 0.1 | 0.3 | 1.5 | 3.3 | 6.2 |
| Septal | | | | | |
| Penetration | | | | | |
| (%) | | | | | |

As illustrated by Table 1, a “low energy very high sensitivity” (LEVHS) performance point may be achieved using a collimator assembly having a length of 17 millimeters; a “low energy high sensitivity” (LEHS) performance point may be achieved using a collimator assembly having a length of 21 millimeters; a “low energy general purpose” (LEGP) performance point may be achieved using a collimator assembly having a length of 26 millimeters; a “low energy high resolution” (LEHR) performance point may be achieved using a collimator assembly having a length of 35 millimeters; and a “low energy very high resolution” (LEVHR) performance point may be achieved using a collimator assembly having a length of 44 millimeters.

As will be appreciated by those of ordinary skill in the art, the above-listed performance points may be achieved using an exemplary modular multi-hole collimator assembly 42, in accordance with embodiments of the present technique. By way of example, the performance points may be realized by using a base multi-hole collimator unit 44 (17 mm hole length) and various combinations of multi-hole collimator extension units 58, 64, and/or 66 (4 or 17 mm hole length). Table 2 below illustrates the various combinations that may be utilized to achieve the requisite hole length:

TABLE 2

| | LEHVR | LEHR | LEGP | LEHS | LEVHS |
|---|---|---|---|---|---|
| Total Hole | 44 | 35 | 26 | 21 | 17 |
| Length (mm) | | | | | |
| Base | 17 | 17 | 17 | 17 | 17 |
| Collimator | | | | | |
| Hole Length | | | | | |
| (mm) | | | | | |
| First | 9 | 9 | 9 | 4 | — |
| Collimator | | | | | |
| Extension | | | | | |
| Hole Length | | | | | |
| (mm) | | | | | |
| Second | 9 | 9 | — | — | — |
| Collimator | | | | | |
| Extension | | | | | |
| Hole Length | | | | | |
| (mm) | | | | | |
| Third | 9 | — | — | — | — |
| Collimator | | | | | |
| Extension | | | | | |
| Hole Length | | | | | |
| (mm) | | | | | |

Each of the multi-hole collimator units listed in Table 2 would have a 1.5 millimeter hexagonal hole diameter and 0.2 millimeter septa thickness, in accordance with one embodiment of the present technique. Those of ordinary skill in the art will appreciate that each of the possible combinations of modular multi-hole collimator units will require calibration by well-known techniques for use during image reconstruction. By way of example, a sensitivity map may be acquired for each combination (e.g., LEVHS, LEHS, LEGP, etc.) to correct the projection data acquired during SPECT or planar imaging.

Any suitable technique may be used to couple the multi-hole collimator units, such as the first multi-hole extension unit 58 and the base multi-hole collimator unit 44. By way of example, one or more alignment pins may be utilized that extend through corresponding holes in each of the multi-hole collimator units. In this manner, the collimator units may be coupled to one another while the holes therethrough are held in alignment. Alternatively, the multi-hole collimators units may be coupled using a rack system in which each of the multi-hole collimator units may be installed. By way of example, each of the multi-hole collimator units selected for use may be installed into the rack system so that the holes therethrough are in alignment with one another.

Those of ordinary skill in the art will appreciate that multi-hole collimator cores may be made from lead (Pb), which is a soft, easily deformable metal, although they may also be made from other metals, such as tungsten (W), or various metal alloys or metal/ceramic compounds, that provide more strength and rigidity. By way of example, when a collimator core is deformable, a thin aluminum (Al) cover plate on each exposed side of the collimator unit may provide protection from impact damage. If the protective covers remain in place when multiple modules are stacked together, they will attenuate and/or scatter some gamma rays, and this performance characteristic must be considered and calibrated. Alternatively, the protective covers between stacked modules may be removed when the modular collimator units are coupled together.

Furthermore, those of ordinary skill in the art will appreciate that, in exemplary embodiments, the modular multi-hole collimator units should be securely fastened together and to the gantry 16 that also holds the detector assemblies 14. The mechanical coupling mechanism should be stable and strong, for example, to prevent any relative movement between the detector assemblies 14 and the collimator assemblies 12, considering rotation of the gantry 16 and any additional movement required to bring the collimator assemblies 12 into close proximity of the subject 30. As will be appreciated, image reconstruction typically assumes no relative movement between collimator and detector. Further, the mechanical coupling mechanism must should strong to prevent any part of the collimator assemblies 12 from falling and injuring the subject 30.

While the preceding discussion generally describes SPECT imaging, the modular multi-hole collimator assemblies describe above may be suitable for use in other non-invasive imaging techniques such as planar gamma ray imaging. To produce a planar image, one or more detector assemblies may be placed in stationary positions around a subject, such as detector assemblies 14 placed around subject 30 on FIG. 1.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A collimator assembly, comprising:
a modular multi-hole collimator assembly configured to have an adjustable length by coupling two or more multi-hole collimator units, each of the two or more multi-hole collimator units having a plurality of holes therethrough.

2. The collimator assembly of claim 1, wherein the plurality of holes in the multi-hole collimator units are defined by septa that comprise substantially radiation-absorbent material.

3. A modular multi-hole collimator assembly, comprising:
a base multi-hole collimator unit having a plurality of holes therethrough; and
a multi-hole collimator extension unit having a plurality of holes therethrough, wherein at least one of the plurality of holes through the base multi-hole collimator unit and at least one of the holes through the multi-hole collimator extension unit are axially aligned.

4. The modular multi-hole collimator assembly of claim 3, wherein the plurality of holes in the base multi-hole collimator unit and the plurality of holes in the multi-hole collimator extension unit are defined by septa that comprise substantially radiation-absorbent material.

5. The modular multi-hole collimator assembly of claim 3, wherein the plurality of holes through the base multi-hole collimator unit are generally parallel with respect to one another.

6. The modular multi-hole collimator assembly of claim 3, wherein the plurality of holes through the base multi-hole collimator unit generally converge from one end of the base multi-hole collimator unit to another end thereof.

7. The modulator multi-hole collimator assembly of claim 3, wherein the multi-hole collimator extension unit is coupled to the base multi-hole collimator unit.

8. The modular multi-hole collimator assembly of claim 3, wherein the plurality of holes through the base multi-hole collimator unit have a different length than the plurality of holes through the multi-hole collimator extension unit.

9. The modular multi-hole collimator assembly of claim 3, wherein the plurality of holes through the base multi-hole collimator unit have a length in the range of from about 5 mm to about 50 mm, and wherein the plurality of holes through the multi-hole collimator extension unit have a length in the range of from about 2 mm to about 30 mm.

10. The modular multi-hole collimator assembly of claim 3, wherein the plurality of holes through the base multi-hole collimator unit and the plurality of holes through the multi-hole collimator extension unit each have substantially the same diameter.

11. The modular multi-hole collimator assembly of claim 3 wherein the modular multi-hole collimator assembly comprises a second multi-hole collimator extension unit having a plurality of holes, wherein at least one of the plurality of holes through the second multi-hole collimator extension unit are axially aligned with at least one of the holes through the multi-hole collimator extension unit.

12. An imaging system, comprising a modular multi-hole collimator assembly configured to have an adjustable length by coupling two or more multi-hole collimator units, each of the two or more multi-hole collimator units having a plurality of holes therethrough; and
a detector assembly configured to generate one or more signals in response to gamma rays that pass through pathways defined by the modular multi-hole collimator assembly.

13. The imaging system of claim 12, wherein the modular multi-hole collimator assembly comprise a base multi-hole collimator unit having a plurality of holes therethrough, and a multi-hole collimator extension unit coupled to the base multi-hole collimator unit and having a plurality of holes therethrough, wherein at least one of the plurality of holes through the base multi-hole collimator unit and at least one of the holes through the multi-hole collimator extension unit are axially aligned.

14. The imaging system of claim 13, wherein the plurality of holes through the base multi-hole collimator unit have a length in the range of from about 5 mm to about 50 mm, and wherein the plurality of holes through the multi-hole collimator extension unit have a length in the range of from about 2 mm to about 30 mm.

15. The imaging system of claim 12, wherein the modular multi-hole collimator assembly and the detector assembly are coupled to a gantry.

16. The imaging system of claim 15, wherein the imaging system comprises one or more additional modular multi-hole collimator assemblies coupled to the gantry and configured to have an adjustable length by coupling two or more multi-hole collimator units, each of the one or more additional modular multi-hole collimator assemblies having a corresponding detector assembly coupled to the gantry and configured to generate one or more signals in response to gamma rays that pass through pathways defined by the corresponding one or more additional modular multi-hole collimator assemblies.

17. The imaging system of claim 12, wherein the detector assembly comprises at least one of an array of solid-state detector elements or a scintillator assembly coupled to light sensors.

18. The imaging system of claim 12, comprising:
a module configured to receive the one or more signals and to process the one or more signals to generate one or more images; and
an image display workstation configured to display the one or more images.

19. A method of changing collimator performance, comprising:
coupling a multi-hole collimator extension unit having a plurality of holes therethrough to a modular collimator assembly comprising one or more multi-hole collimator units having a plurality of holes therethrough so that at least one of the plurality of holes through the multi-hole- collimator units and at least one of the holes through the multi-hole collimator extension unit are axially aligned.

20. The method of claim 19, comprising coupling a second multi-hole collimator extension unit having a plurality of holes therethrough to the multi-hole collimator extension unit so that at least one of the plurality of holes through the second multi-hole collimator extension unit and at least one of the holes through the multi-hole collimator extension unit are axially aligned.

21. The method of claim 19, comprising selecting the multi-hole collimator extension unit at least based on system resolution and/or sensitivity.

22. The method of claim 19, comprising collimating gamma rays with the modular collimator assembly, and detecting the collimated gamma rays.

23. A method of changing collimator performance, comprising:
removing a multi-hole collimator extension unit having a plurality of holes therethrough from a modular collimator assembly comprising the multi-hole collimator extension unit coupled to the base multi-hole collimator unit having a plurality of holes therethrough, wherein at least one of the plurality of holes through the base multi-hole collimator unit at least one of the holes through the multi-hole collimator extension unit are axially aligned.

24. The method of claim 23, comprising collimating gamma rays with the modular collimator assembly, and detecting the collimated gamma rays.

25. A method of imaging a volume, comprising:
positioning at least a portion of a subject in field of view of an imaging system;
collimating gamma rays emitted from the subject using a modular multi-hole collimator assembly, wherein gamma rays aligned with pathways formed by holes of the modular multi-hole collimator assembly pass through the modular multi-hole collimator assembly, and wherein the modular multi-hole collimator assembly substantially absorbs gamma rays not aligned with one of the pathways;
detecting the collimated gamma rays; and
generating one or more signals in response to the collimated gamma rays.

26. The method of claim 25 wherein the modular multi-hole collimator assembly comprises a base multi-hole collimator unit and one or more multi-hole collimator extension units.

27. The method of claim 25 comprising calibrating collimator performance of the modular multi-hole collimator assembly and using the calibration to produce images.
